(19) United States
(12) Patent Application Publication
(10) Pub. No.: US 2025/0389323 A1
(43) Pub. Date: Dec. 25, 2025

(54) MULTI-PIECE CLUTCH GEAR ASSEMBLY

(71) Applicant: Dana Automotive Systems Group, LLC, Maumee, OH (US)

(72) Inventors: Kyle MOURDOCK, Bowling Green, OH (US); Andrew C. SHUPE, Waterville, OH (US); Byron SOLHEIM, Holland, OH (US); Clairese KLUBA, Maumee, OH (US)

(21) Appl. No.: 19/204,319

(22) Filed: May 9, 2025

Related U.S. Application Data
(60) Provisional application No. 63/645,461, filed on May 10, 2024.

(51) Int. Cl. F16H 55/17; F16H 55/06

(52) U.S. Cl. CPC F16H 55/17; F16H 55/06; F16H 2055/178

(57) ABSTRACT

Systems are provided herein for a multi-piece clutch gear assembly. In one example, a multi-piece clutch gear assembly comprises a helical gear and a clutch assembly, wherein the clutch assembly is coupled to and arranged within an interior of the helical gear, wherein the helical gear and the clutch assembly are formed as separate pieces and configured to be affixed together.

### CROSS REFERENCE TO RELATED APPLICATIONS

The present application claims priority to U.S. Provisional Application No. 63/645,461 entitled “MULTI-PIECE CLUTCH GEAR ASSEMBLY”, filed on May 10, 2024. The entire contents of the above-listed application is hereby incorporated by reference for all purposes.

### TECHNICAL FIELD

Embodiments of the subject matter disclosed herein relate to electric vehicles, and more specifically to a multi-piece clutch gear assembly.

### BACKGROUND AND SUMMARY

Electric vehicles make use of electric drive units to generate motive power and provide an attractive alternative in terms of hydrocarbon emissions in relation to vehicles that solely rely on internal combustion engines for propulsion. Electric drive units often comprise transmission that include a plurality of clutches, gears, and shafts to transfer mechanical power from one or more motors to downstream components. In some systems, clutch gear assemblies, where a clutch is integrated into a gear, are used to provide increased space efficiency, as adding clutches to the transmission separate from gears increases overall needed packaging space.

However, with integrating the clutch into the gear, the clutch interface, for example the interface including the teeth or notches in dog clutch examples, are required to be the same material as the base helical gear as the two are formed together. This also requires that the clutch interface be formed in a similar fashion as the helical gear. The manufacturing process of the helical gear thus dictates the process that the clutch interface must be formed in. This forced process can increase size, cost, and complexity of the gear overall. Because of this, compromises may be taken in terms of performance for either the gear or the clutch in order to achieve the manufacturing.

The inventors herein have recognized the aforementioned issues and developed a multi-piece gear with integrated clutch, referred to herein as a clutch gear assembly. The multi-piece clutch gear assembly herein disclosed includes a first piece including the helical gear portion and a second piece including the clutch portion. The clutch portion includes the clutch interface and the central hub through which a shaft may be positioned.

The clutch portion may be formed of any type of material, including cast iron, forged steel, powdered metal, and the like. Similarly, the helical gear may be formed of any type of desired material. The clutch portion and the helical gear portion may thus be formed of different materials, if so desired. In this way, materials may be specifically chosen to optimize performance of the clutch gear assembly and system in which it is positioned, such as a transmission system. For example, the separate pieces allow the hardness, material, density, etc. to be adjusted specifically for the assembly so as to affect audible noise (e.g., noise, vibration, and harshness (NVH)) of the clutch and/or the gear during engagement, overrun, normal function, and/or gear mesh and misalignment.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an exemplary vehicle.

FIG. 2 shows a perspective view of a multi-piece clutch gear assembly comprising a helical gear and a clutch assembly.

FIG. 3A shows a cross-sectional view of the multi-piece clutch gear assembly in a single clutch arrangement, according to a first embodiment of the present disclosure.

FIG. 3B shows a cross-sectional view of the multi-piece clutch gear assembly in a single clutch arrangement, according to a second embodiment of the present disclosure.

FIG. 4 shows a cross-sectional view of the multi-piece clutch gear assembly in a dual-clutch arrangement.

FIG. 5 shows a perspective view of the helical gear of the multi-piece clutch gear assembly, according to the first embodiment of the present disclosure.

FIG. 6 shows a perspective view of the clutch assembly of the multi-piece clutch gear assembly, according to the first embodiment of the present disclosure.

FIG. 7 shows a perspective view of the clutch assembly of the multi-piece clutch gear assembly, according to the second embodiment of the present disclosure.

FIG. 8 shows a perspective view of the helical gear of the multi-piece clutch gear assembly, according to the second embodiment of the present disclosure.

### DETAILED DESCRIPTION

The following description relates to systems and methods for a multi-piece gear with integrated clutch, referred to herein as a multi-piece clutch gear assembly. The multi-piece clutch gear assembly comprises a helical gear and a clutch assembly that are formed separate from one another and assembled together. The multi-piece clutch gear assembly as herein disclosed may be integrated into a vehicle, for example an electric vehicle, in a transmission and/or axle assembly.

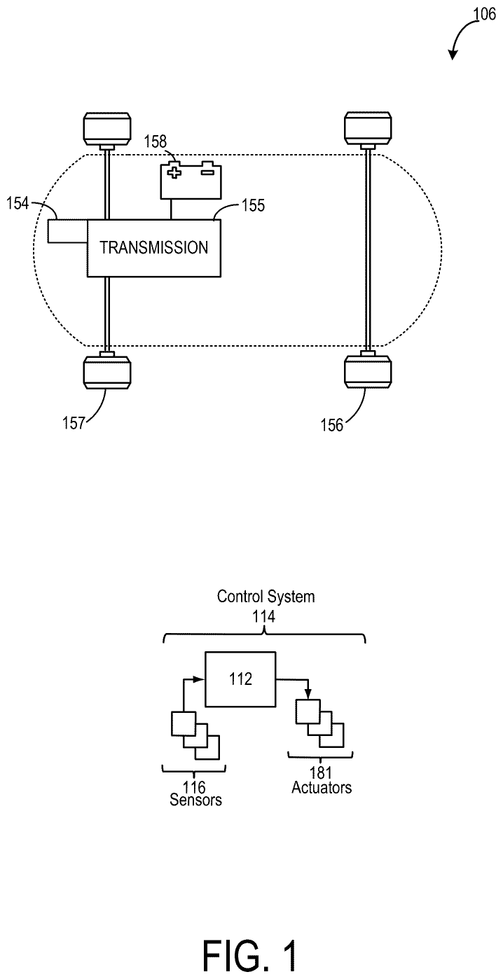

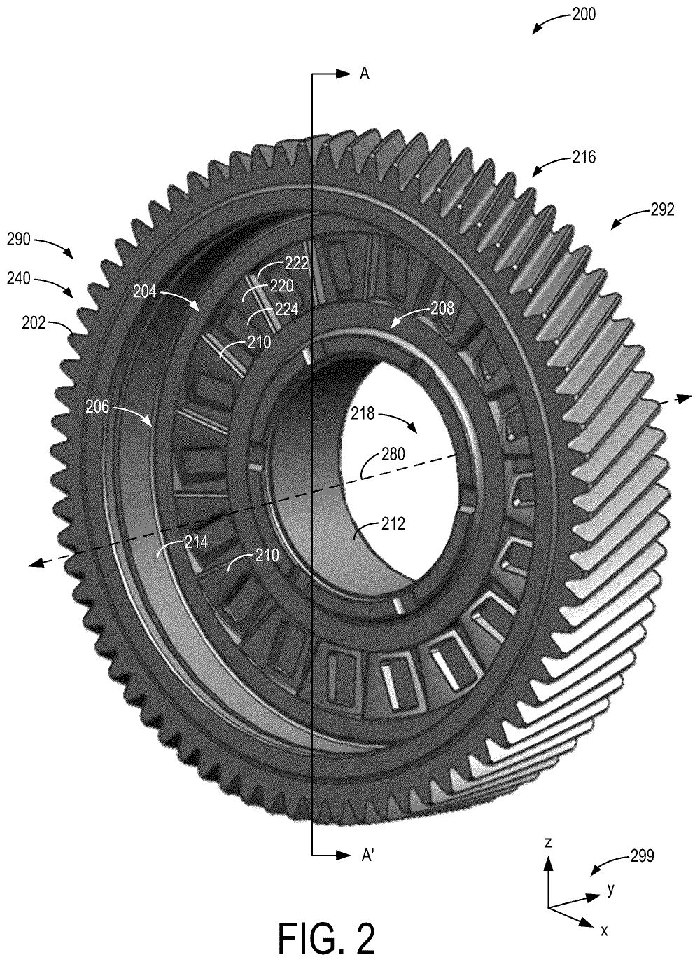

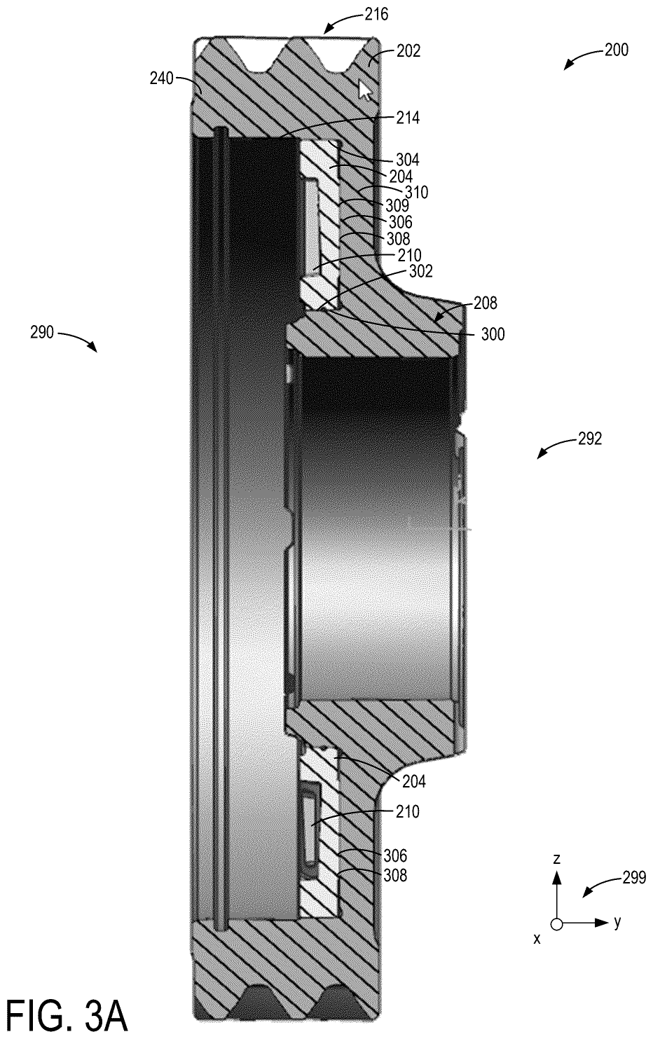

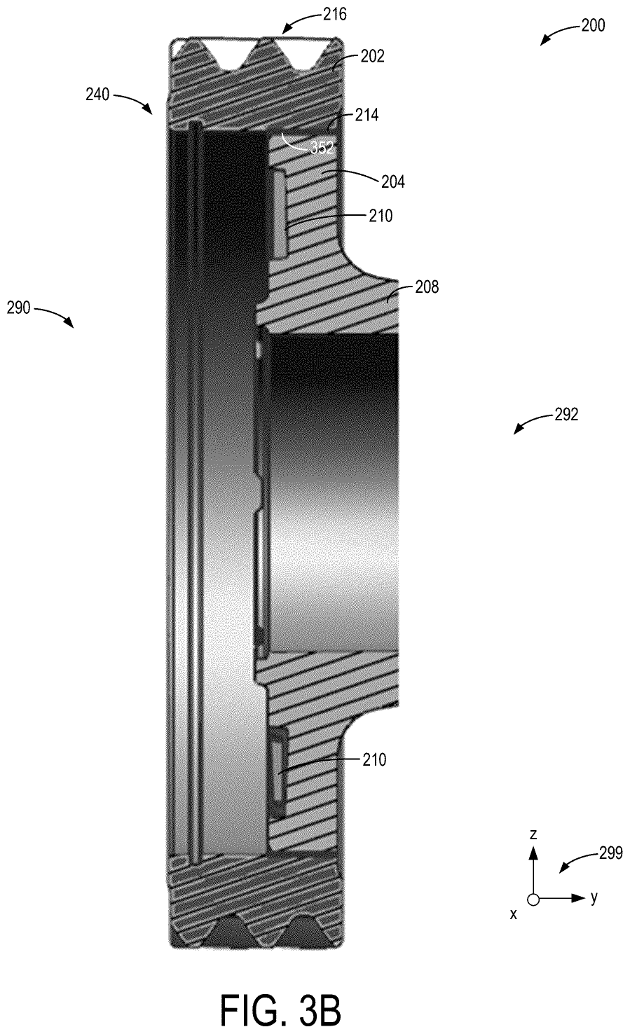

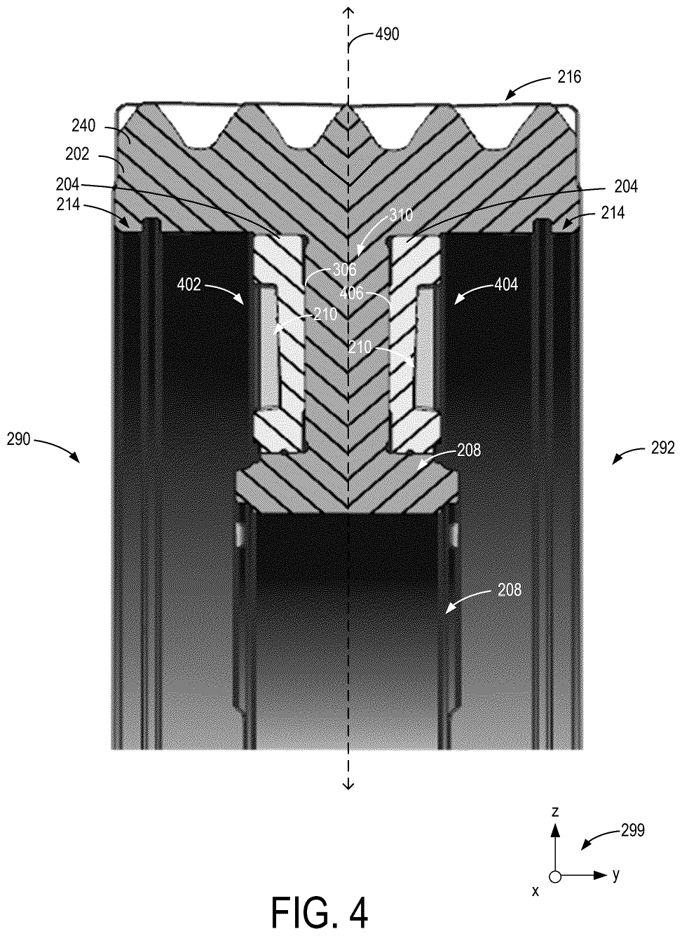

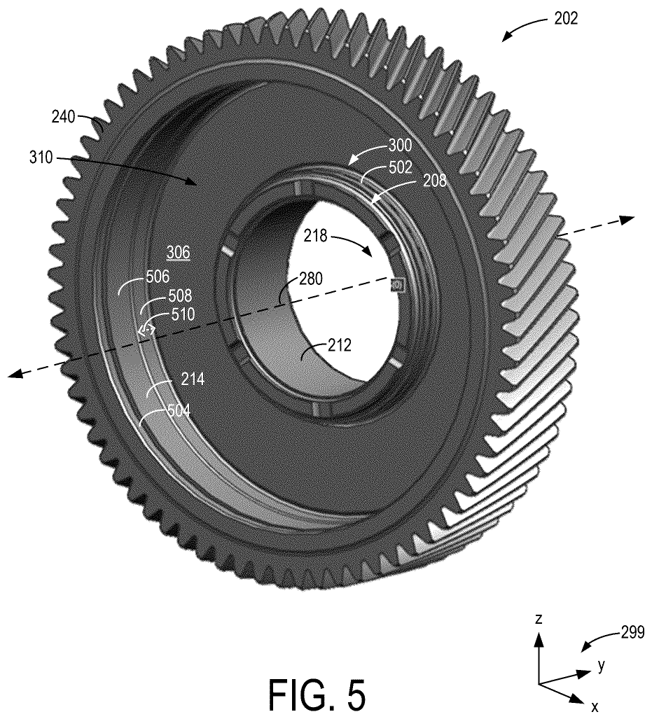

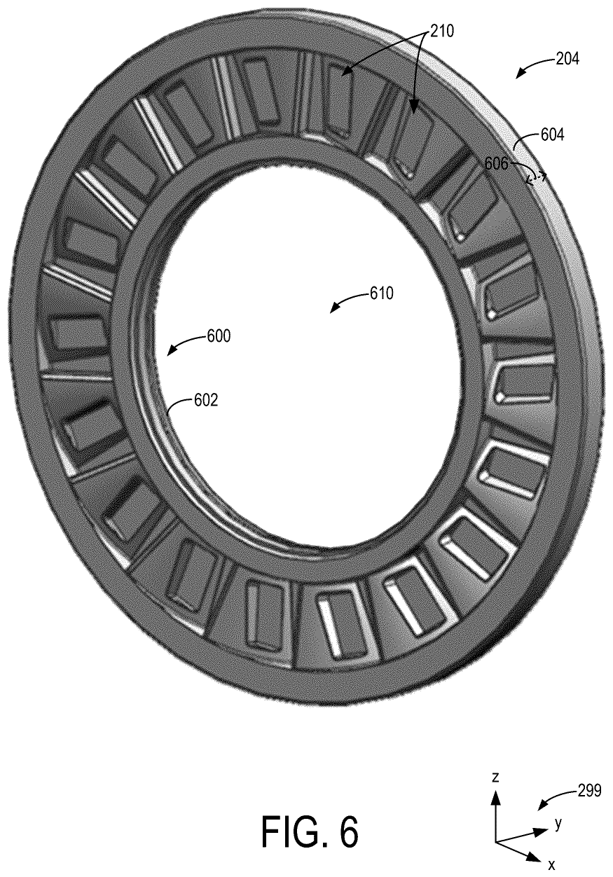

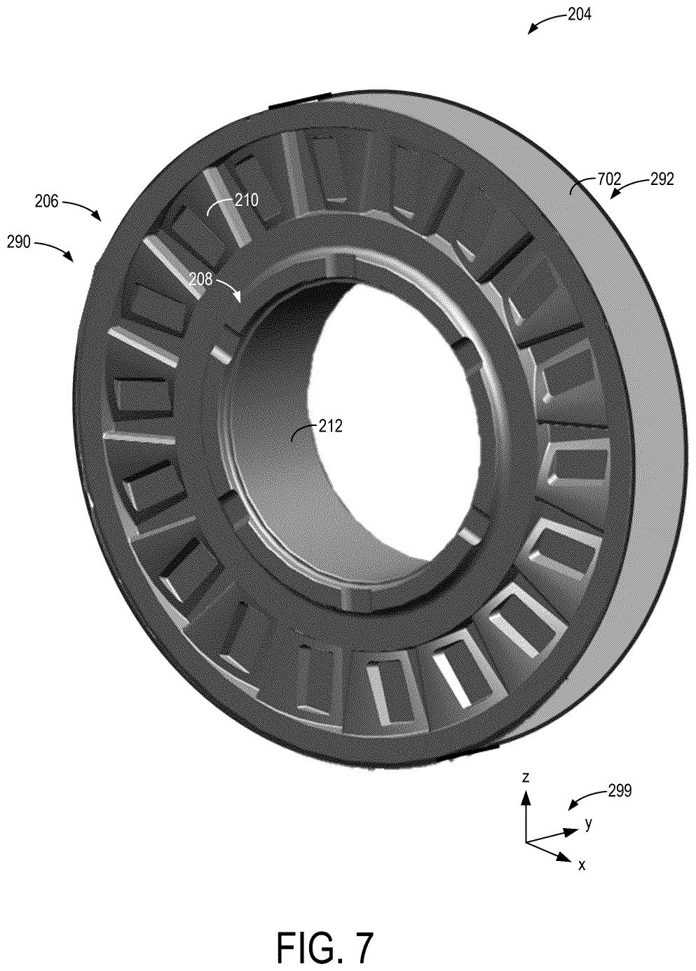

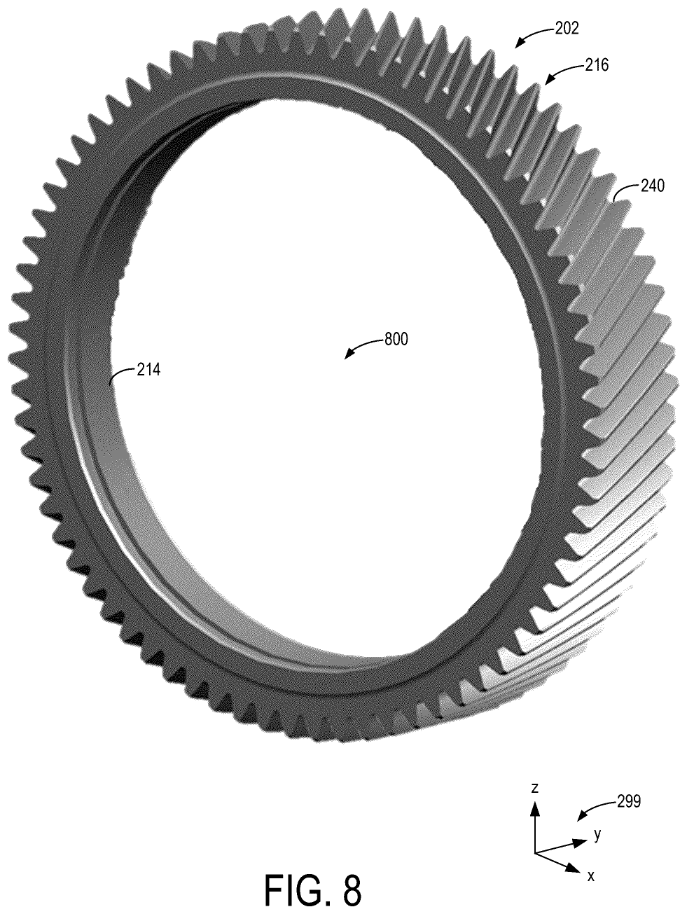

An exemplary electric vehicle is shown in FIG. 1. An exemplary multi-piece clutch gear assembly is shown in FIG. 2 in a perspective view, the multi-piece clutch gear assembly comprising a helical gear and a clutch assembly assembled together. Cross-sectional views of the multi-piece clutch gear assembly are shown in FIGS. 3A, 3B, and 4. The helical gear of the multi-piece clutch gear assembly is shown according to a first embodiment in FIG. 5 and according to a second embodiment in FIG. 8. The clutch assembly is shown according to the first embodiment in FIG. 6 and according to the second embodiment in FIG. 7.

FIGS. 2-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to the figures, FIG. 1 shows a schematic depiction of a vehicle system 106 that can derive propulsion power from one or more electric motors 154 (e.g., a drive motor). In some examples, the vehicle system 106 may be a front loader or compact wheel loader vehicle system. In one embodiment, the electric motor 154 may be a traction motor. Electric motor 154 receives electrical power from a traction battery 158 to provide torque to rear vehicle wheels 157 via transmission 155. Electric motor 154 may also be operated as a generator to provide electrical power to charge traction battery 158, for example, during a braking operation. It should be appreciated that while FIG. 1 depicts the electric motor 154 and transmission system 155 mounted in a rear wheel drive configuration, other configurations are possible, such as employing the electric motor 154 in a front wheel configuration, or in a configuration in which a first output yoke or other interface drives the rear vehicle wheels 157 and a second output yoke or other interface drives front vehicle wheels 156.

Electric motors 154 and transmission 155 may be included as part of an electric drive unit. In some examples, the electric motor 154 may be integrated with a gearbox of the transmission system 155. Additionally or alternatively, the electric motor 154 may be coupled to an outside of a transmission/gearbox housing. The transmission/gearbox may include combinations of one or more gears, one or more clutches, and one or more shafts. Controller 112 may send a signal to an actuator of the clutch(es) to engage or disengage the clutch(es), so as to couple or decouple power transmission from the electric motor 154 to various shafts and gears therein.

Controller 112 may form a portion of a control system 114. Control system 114 is shown receiving information from a plurality of sensors 116 and sending control signals to a plurality of actuators 181. As one example, sensors 116 may include sensors such as a battery state of charge sensor, clutch pressure sensor, speed sensors etc. As another example, the actuators may include the clutch(es), etc. The controller 112 may receive input data from the various sensors, process the input data, and trigger the actuators in response to the processed input data based on instruction or code programmed therein corresponding to one or more routines.

Turning now to FIG. 2, a multi-piece clutch gear assembly 200, also referred to herein as the clutch gear assembly 200, according to the present disclosure is shown. The clutch gear assembly 200 may comprise a helical gear 202 and a clutch assembly 204. A set of reference axes 299 are provided in FIG. 2 as well as FIGS. 3-7C. The reference axes 299 indicate a y-axis, an x-axis, and a z-axis. In one example, the z-axis may be parallel with a direction of gravity and the x-y plane may be parallel with a horizontal plane that a transmission block may rest upon. For example, the y-axis may be a lateral axis and the x-axis may be a longitudinal axis. The clutch gear assembly 200 may be centered about an axis of rotation 280.

In a first embodiment of the present disclosure, the helical gear 202 of the clutch gear assembly 200 comprises a ring 240 and a central hub 208 and the clutch assembly 204 comprises at least one clutch interface 206. In the first embodiment, the clutch assembly 204 may be arranged within the ring 240, as will be described below.

In a second embodiment of the present disclosure, the helical gear 202 may comprise the ring 240 and the clutch assembly 204 may comprise the central hub 208 and the at least one clutch interface 206. In some examples, a thickness of the ring 240 may be different, e.g., smaller, in the second embodiment compared to the first embodiment, such as when the clutch assembly 204 additionally comprises a ring positioned around the central hub 208 and clutch interface 206. In other examples, the ring 240 of the helical gear 202 may be substantially similar in the second embodiment compared to the first embodiment.

In the second embodiment, the clutch assembly 204 may be arranged within the ring 240 of the helical gear 202. In some examples, the clutch assembly 204 may comprise a ring arranged around the clutch interface 206 and the central hub 208 configured to be positioned within the ring 240 of the helical gear 202. In other examples however, the clutch assembly 204 may not comprise a ring.

In both embodiments, the helical gear 202 may comprise an outer surface 216 of the ring 240. The outer surface 216 may comprise a plurality of teeth located radially, with respect to the axis of rotation 280, about a perimeter of the helical gear 202. The plurality of teeth may be configured to engage or mesh with the teeth of another gear to drivingly couple the clutch gear assembly 200.

In both embodiments, the clutch assembly 204 may comprise at least one clutch interface 206. In some examples, the clutch assembly 204 comprises one clutch interface 206, as shown in the example illustrated in FIGS. 3A-3B. In other examples, the clutch assembly comprises two clutch interfaces 206, as shown in the example illustrated in FIG. 4. In the first embodiment, the clutch assembly 204 may also comprise at least one non-clutch interface (not shown). In one-example, the non-clutch interface of the clutch assembly 204 may be a substantially flat face on an opposing side as the clutch interface 206. In other examples however, the non-clutch interface may comprise one or more mating components such as splines, recesses, notches, or the like, configured to couple to a corresponding face of the helical gear 202.

The central hub 208 may be arranged within an interior of the ring 240. For example, the central hub 208 may be arranged within an interior of ring 240 such that the ring 240 and the central hub 208 have the same shared axis of rotation 280. The central hub 208 may be configured with a passage 218 there through, wherein the axis of rotation 280 is centered in the middle of the passage 218. Thus, the clutch gear 200 may be positioned on a shaft, wherein the shaft passes through the passage 218. An inner surface 212 of the central hub 208 may be radial and smooth with respect to the axis of rotation 280. The clutch interface 206 may be positioned towards a first side 290 of the clutch gear assembly 200, opposite a second side 292.

The clutch interface 206 is shown in FIG. 2 as a dog clutch interface, though it should be understood that other types of clutch interfaces, including friction clutch interfaces, are also possible. The clutch interface 206, when configured as a dog clutch interface, may comprise a plurality of notches 210. Each of the plurality of notches 210 may include a sloping face 220, a step 222 that extends from a high edge of the sloping face 220 of a first notch to a low edge of the sloping face 220 of a second, adjacent notch, and an inner notch 224. The plurality of notches 210 thus may be configured to interlock with a corresponding interface when engaged.

The clutch assembly 204 may be integrated into an interior of the helical gear 202, as will be further described with respect to FIGS. 3A-8. For example, an interior surface 214 of the helical gear 202 may be affixed to an exterior surface of the clutch assembly 204. For example, a retention interface may be formed between the two pieces when the clutch assembly 204 is integrated into the helical gear 202. The clutch assembly 204 may be integrated, e.g., coupled to, the interior of the helical gear 202 via press fitting, threading, inside diameter or outside diameter lug/spline interface, welding a joint, or the like.

Integrating the clutch assembly into an interior of the helical gear may reduce packaging space needed compared to if the clutch assembly was assembled separate from the helical gear. However, traditional methods for integrating clutch into a helical gear demands that the clutch assembly and helical gear be manufactured as one piece and therefore be formed of the same materials, which may result in compromises with regards to performance for one or both of the gear and the clutch.

The helical gear 202 may be formed as a single piece. The helical gear 202 may be manufactured from any desired or feasible material, such as cast iron, forged steel, powdered metal, or the like. The clutch interface 206 and the central hub 208 may be formed as one piece during manufacturing of the clutch assembly 204. The clutch assembly 204 may be manufactured from any desired or feasible material, such as cast iron, forged steel, powdered metal, or the like. The clutch assembly 204 may be formed from a different material from the helical gear 202, in some examples. The separate pieces thus allow the hardness, material, density, and other parameters, to be adjusted specifically for the intended use case, end application, and the like. For example, the hardness, material, density, and the like may affect audible noise, for example from noise, vibration, and harshness (NVH) of the clutch and the helical gear. For example, the NVH of the clutch may occur during engagement of the clutch, during overrun, or during normal function, whereas the NVH of the helical gear, namely from the teeth of the gear, may stem from the overall gearbox noise made from gear mesh and misalignment. A material chosen to optimize the NVH of the helical gear may not be ideal for NVH of the clutch. Similarly, a material chosen to optimize NVH of the clutch may not be idea for NVH of the gear. In this way, the separate pieces of the clutch gear assembly may allow for different materials to be chosen in order to reduce or otherwise affect NVH and other parameters in both the clutch and the helical gear.

Turning now to FIGS. 3A and 3B, the multi-piece clutch gear assembly 200 of FIG. 2 is shown in cross-section. FIG. 3A specifically shows a cross-section of the multi-piece clutch gear assembly 200 according to the first embodiment and FIG. 3B specifically shows a cross-section of the multi-piece clutch gear assembly 200 according to the second embodiment. The cross-sections shown in FIGS. 3A and 3B are taken across cutting plane A to A′ shown in FIG. 2. As described previously, the multi-piece clutch gear assembly 200 may comprise a first piece, e.g., the helical gear 202, and a second piece, e.g., the clutch assembly 204 comprising the clutch interface 206 and the central hub 208. In the first embodiment, the helical gear 202 may comprise the ring 240 and the central hub 208, formed as a single piece, which is coupled to the clutch assembly 204. In the second embodiment, the helical gear 202 may comprise just the ring 240, which is coupled to the clutch assembly 204 which comprises the central hub 208, the clutch interface 206, and in some examples, a ring.

In either embodiment, the clutch assembly 204 may be arranged within an interior of the helical gear 202, for example at an interior surface 214 of the ring 240.

Starting with the first embodiment shown in FIG. 3A, the clutch assembly 204 may additionally be coupled to an outer surface 300 of the central hub 208, as will be further described with respect to FIGS. 5 and 6. The clutch assembly 204 and the interior surface 214 of the ring 240, when coupled, may form a retention interface 304. As previously noted, the retention interface 304 may be formed by press fitting, outer diameter or interior diameter lug/spline interfacing, forming a welding joint, or the like.

Additionally, a non-clutch interface face 309 of the clutch assembly 204 may couple to or otherwise directly contact a face 306 of a plate 310 of the helical gear 202. The non-clutch interface face 309 may be a backside of the clutch assembly 204 with respect to the clutch interface 206. For example, the helical gear 202 may comprise a substantially flat plate 310, as shown in FIG. 5, which is parallel with the z-axis and perpendicular to the axis of rotation 280. The face 306 of the plate 310 may be positioned towards the first side 290. The plate 310 may be coupled to or otherwise formed with the ring 240 and the central hub 208. The non-clutch interface face 309 of the clutch assembly 204 and the face 306 of the plate 310, when coupled, may form interface 308. This may or may not be a retention surface as it may or may not contribute to maintaining the relative positions of the clutch assembly 204 and the helical gear 202.

In some examples, the clutch assembly 204 and the outer surface 300 of the central hub 208, when coupled, may also form a retention interface 302. In such examples, as will be described below, the retention interface 302 between the clutch assembly 204 and the central hub 208 may be formed by spline interfacing, welding, press fitting, or the like.

Referring to the second embodiment shown in FIG. 3B, the clutch assembly 204 may be affixed to the interior surface 214 of the ring 240 of the helical gear 202. The clutch assembly 204 and the helical gear 202, when affixed to each other, may form a retention interface 352. As noted previously, the retention interface 352 may be formed by press fitting, outer diameter or interior diameter lug/spline interfacing, forming a welding joint, or the like.

In the examples shown in FIGS. 3A and 3B, the helical gear 202 may be substantially circular in shape. In some examples, the helical gear 202 may narrow in diameter at the second side 292 compared to the first side 290. In other examples, the helical gear 202 may have the same diameter across the y-direction (excluding recesses of the teeth of the outer surface 216).

In the example shown in FIGS. 3A and 3B, the clutch assembly 204 only comprises one clutch interface 206 and the multi-piece clutch gear assembly 200 may be considered one-sided (e.g., with a clutch interface only disposed at and/or facing one of the two sides, such as at the first side 290). In such an example, the ring 240 of the helical gear 202 may be disposed more towards the first side 290 than the second side 292. Similarly, the central hub 208, whether included in the helical gear 202 or the clutch assembly 204, may be disposed more towards the second side 292 than the first side 290.

Turning now to FIG. 4, a portion of a cross-sectional view across cutting plane A to A′ of the clutch gear assembly 200 is shown, illustrating the clutch assembly 204 with two clutch interfaces 206. The clutch assembly 204 with two clutch interfaces 206 may be possible in either of the first or second embodiments described above, though FIG. 4 is depicted according to the first embodiment for the sake of illustration.

In this example, the clutch assembly 204 may comprise a first clutch interface 402 and a second clutch interface 404. The first clutch interface 402 may be positioned at the first side 290 of the clutch gear assembly 200 and the second clutch interface 404 may be positioned towards the second side 292 of the clutch gear assembly 200. The first and second clutch interfaces 402, 404 may be similar to the clutch interface 206 described above. For example, the first and second clutch interfaces 402, 404 may both comprise a plurality of notches 210 configured for interfacing with a mated clutch.

Thus, the clutch assembly 204 may be configured with a dual-clutch arrangement, hence including the first and second clutch interfaces. In contrast, in the example shown in FIGS. 3A and 3B, the clutch assembly 204 may comprise only one clutch interface and thus may be configured with a single clutch arrangement. The single clutch arrangement may be suitable for two-speed transmission systems. The dual-clutch arrangement, conversely, may be suitable for three or more transmission/axle systems. In this way, the multi-piece clutch gear assembly 200 as herein disclosed may be configured for end use application, providing for increased flexibility.

For the dual-clutch arrangement shown in FIG. 4, the multi-piece clutch gear assembly 200 may be double sided. For example, the ring 240 of the helical gear may span from the first side 290 to the second side 292, with the central hub 208 and the plate 310 disposed centrally between the first and second sides 290, 292. For example, the central hub 208 and the plate 310 may be centered at a midline 490. In some examples, the plate 310 may have the same thickness in the dual-clutch arrangement as in the single clutch arrangement and in other examples, the plate 310 may be thicker in the dual-clutch arrangement compared to the single clutch arrangement.

The first clutch interface 402 may couple to or contact the face 306 of the plate 310, as described above, wherein the face 306 is positioned towards the first side 290 of the plate 310. The second clutch interface 404 may couple to or otherwise directly contact a second face 406 of the plate 310, wherein the second face 406 is positioned towards the second side 292 of the plate 310.

In the first embodiment where the central hub 208 is formed as part of the helical gear 202, the two clutch interfaces 402 and 404 of the clutch assembly 204 may be realized as two separate components that are not physically joined together but rather arranged at opposing sides of the helical gear 202. In the second embodiment where the central hub 208 is formed as part of the clutch assembly 204, the two clutch interfaces 402 and 404 of the clutch assembly 204 may be realized as a single component with two conceptual mirrored halves and the central hub 208 disposed centrally between the two clutch interfaces 402, 404.

Turning now to FIG. 5, the helical gear 202 is shown uncoupled from the clutch assembly 204, according to the first embodiment of the present disclosure. As described herein, in the first embodiment, the helical gear 202 may comprise the ring 240 and the central hub 208 configured as a single piece, for example with the plate 310 therebetween as described above.

The helical gear 202 may comprise the plate 310. As described previously, the plate 310 may be an inner vertically oriented (e.g., parallel to the z-axis) plate of the helical gear 202 that is configured to couple to or otherwise directly contacts the non-clutch interface of the clutch assembly 204 when the clutch assembly 204 is coupled with the helical gear 202. The interior surface 214 of the ring 240 may comprise an outer lip 504, a raised middle section 506, and an inner lip 508. The outer lip 504 may be positioned closest to an exterior (e.g., furthest away from the central hub 208). The raised middle section 506 may be raised with respect to the outer lip 504 and the inner lip 508, raised here meaning extending closer to an interior space of the helical gear 202. The inner lip 508 may be a portion of interior surface 214 of the ring 240 arranged closest to the plate 310.

The inner lip 508 may be configured to couple to the clutch assembly 204. For example, the inner lip 508 may have a width 510 that corresponds to a width (e.g., width 606) of an outer surface (e.g., outer surface 604) of the clutch assembly 204. In some examples, the inner lip 508 may be substantially smooth. In other examples, the inner lip 508 may comprise a mating interface, such as one or more splines or grooves, configured to engage a corresponding mating interface of the outer surface of the clutch assembly 204.

In other examples, the interior surface 214 may comprise a different pattern of lips and raised sections and/or may be the same diameter throughout (with the exception of a mating interface like splines or grooves).

The central hub 208 may comprise the outer surface 300 as described previously. The outer surface 300 may be configured to couple to an inner surface (e.g., inner surface 600) of the clutch assembly 204. As a non-limiting example, the outer surface 300 may comprise one or more splines 502 that are configured to mate to one or more splines (e.g., splines 602) of the clutch assembly 204 when the clutch assembly 204 is arranged within the interior of the helical gear 202.

FIG. 6 shows the clutch assembly 204 according to the first embodiment of the present disclosure. In the first embodiment, the clutch assembly 204 may be configured generally as a circular disc with a central circular passage 610. The clutch assembly 204 thus comprises an outer surface 604 and an inner surface 600.

In some examples, the outer surface 604 may be substantially smooth, as shown in FIG. 6, but in other examples, the outer surface 604 may be ridged or splined so as to mate with corresponding splines of an inner surface of the helical gear (e.g., at interior surface 214). The clutch assembly 204, including the outer surface 604 may have a width 606. In some examples, the width 606 may correspond to the width 510 of the inner lip 508 of the helical gear 202. Thus, the clutch assembly 204 may rest against the inner lip 508, inside (or further towards the second side compared to) the raised middle section 506. The raised middle section 506 may thus act to further maintain the relative positions of the clutch assembly 204 and the helical gear 202.

In some examples, the inner surface 600 may comprise one or more splines 602 configured to engage with splines of the outer surface 300 of the central hub 208. It should be understood that other types of mating features other than splines have been envisioned, such as keyways/keys. Further, in other examples, the inner surface 600 may be substantially smooth. The smooth or ridged nature of the inner surface 600 may correspond to the smooth or ridged nature of the outer surface of the central hub 208. For example, when the outer surface of the central hub is smooth, the inner surface of the clutch assembly may be smooth and when the outer surface of the central hub is ridged with splines, the inner surface of the clutch assembly may be ridged with splines for proper engagement. The same may be true for the outer surface 604 of the clutch assembly 204 and the interior surface 214 of the helical gear 202.

FIG. 7 shows the clutch assembly 204 according to the second embodiment of the present disclosure. As described herein, in the second embodiment, the clutch assembly 204 may comprise the central hub 208 and the at least one clutch interface 206.

The clutch interface 206 of the clutch assembly 204 may comprise an outer surface 702. The outer surface 702 may be configured to be affixed to the interior surface 214 of the helical gear 202. In some examples, the outer surface 702 may comprise a plurality of corresponding grooves that correspond to the plurality of grooves of the interior surface 214 of the ring 240 of the helical gear 202. In other examples, such as is shown in FIG. 7, the outer surface 702 may be substantially smooth.

In the single clutch arrangement of the clutch assembly 204, the clutch interface 206 may be positioned towards the first side 290 and the central hub 208 may extend more towards the second side 292. The perspective view of the clutch assembly 204 as shown in FIG. 7 may show the first side 290, in which the plurality of notches 210 are visible. The second side 292 of the clutch assembly 204 that is not shown in FIG. 7 may comprise substantially smooth and/or flat surfaces of differing depths or the same depth (e.g., some portions, like the central hub 208, may extend further towards the second side 292 than others in some examples) when the clutch assembly 204 is in a single clutch arrangement. In a dual-clutch arrangement, the second side 292 of the clutch assembly 204 may include a second clutch interface that is a mirror of the interface 206 shown in FIG. 7. In this way, in the dual clutch arrangement, the clutch assembly may be double sided, thereby allowing for a greater number of speeds of the transmission/axel assembly.

FIG. 8 shows the helical gear 202 according to the second embodiment of the present disclosure. In the second embodiment, the helical gear 202 may comprise the ring 240, which may include the outer surface 216 comprising the plurality of teeth and the interior surface 214.

The helical gear 202 may comprise a second passage 800 formed inside the interior surface 214. In some examples, the interior surface 214 may comprise a plurality of grooves/splines to which the clutch assembly 204 may be affixed. For example, the plurality of grooves may be configured as a spline interface, or a weld joint, or the like.

In some examples, with the exception of the plurality of grooves and the plurality of teeth of the outer surface 216, the helical gear 202 may have a uniform thickness and diameter of the interior surface 214. In other examples, the helical gear 202 may have different circumferences of the interior surface 214. For example, a first circumference of the interior surface may correspond to a circumference of the outer surface of the clutch interface 206 while a second circumference of the interior surface may correspond to a circumference of the outer surface of the central hub 208. Further, the interior surface 214 may comprise the inner lip, the outer lip, and the middle raised section between the inner and outer lips similar as described with respect to FIG. 5. In some examples, the interior surface 214 may comprise a different combination of lips and/or raised sections in the second embodiment, such as an inner raised section, an outer raised section, and a middle non-raised section configured to couple to the outer surface 702 of the clutch assembly 204. Other embodiments, including an entirely smooth interior surface 214 (other than possible mating features like splines) are possible. In this way, the helical gear 202 may be affixed to both the clutch interface and the central hub, thereby increasing the attachment therebetween.

The technical effect of the multi-piece clutch gear assembly herein disclosed is that the clutch assembly is integrated within the gear, which saves packaging space, while maintaining ability to manufacture the gear and the clutch assembly separately. Manufacturing the gear and the clutch assembly separately allows for different materials to be used for each piece, thereby increasing flexibility for optimization of parameters for each piece. In this way, hardness, material, and the like may be selected individually for the gear and the clutch assembly to decrease or otherwise optimize NVH of the overall system.

The disclosure also provides support for a multi-piece clutch gear assembly, comprising: a helical gear, and a clutch assembly coupled to and arranged within an interior of the helical gear, wherein the helical gear is formed as a first piece and the clutch assembly is formed as a separate, second piece. In a first example of the system, the clutch assembly comprises a central hub and at least one clutch interface. In a second example of the system, optionally including the first example, the helical gear comprises a ring, a central hub, and a plate formed as a single piece, wherein the clutch assembly is coupled to an interior surface of the ring and to an exterior surface of the central hub. In a third example of the system, optionally including one or both of the first and second examples in a single clutch arrangement, the clutch assembly comprises a clutch interface positioned towards a first side of the clutch gear assembly and a central hub of the multi-piece clutch gear assembly is positioned more towards a second, opposing side of the clutch gear assembly than the clutch interface. In a fourth example of the system, optionally including one or more or each of the first through third examples in a dual clutch arrangement, the clutch assembly comprises a first clutch interface positioned towards a first side of the clutch gear assembly and a second clutch interface positioned towards a second, opposing side of the clutch gear assembly. In a fifth example of the system, optionally including one or more or each of the first through fourth examples, the helical gear comprises a plurality of teeth at an outer surface thereof configured to mesh with another gear. In a sixth example of the system, optionally including one or more or each of the first through fifth examples, the helical gear is formed of cast iron, forged steel, or powdered metal. In a seventh example of the system, optionally including one or more or each of the first through sixth examples, the clutch assembly is formed of cast iron, forged steel, or powdered metal. In a eighth example of the system, optionally including one or more or each of the first through seventh examples, the helical gear and the clutch assembly are formed of different materials. In a ninth example of the system, optionally including one or more or each of the first through eighth examples, the helical gear and the clutch assembly are configured to be affixed to each other via press fitting, a spline interface, or welding at a retention interface.

The disclosure also provides support for a clutch gear assembly, comprising: a helical gear comprising a ring and a central hub, wherein the central hub is arranged within an interior of the ring along a shared axis of rotation, and a clutch assembly comprising at least one clutch interface, wherein the clutch assembly is coupled to an interior surface of the ring and to an exterior surface of the central hub. In a first example of the system, the central hub comprises an open passage there through, configured to receive a shaft. In a second example of the system, optionally including the first example, the at least one clutch interface comprises a plurality of notches. In a third example of the system, optionally including one or both of the first and second examples, the at least one clutch interface comprises a first clutch interface at a first side of the clutch gear assembly. In a fourth example of the system, optionally including one or more or each of the first through third examples, the at least one clutch interface comprises a second clutch interface at a second side of the clutch gear assembly opposite the first side. In a fifth example of the system, optionally including one or more or each of the first through fourth examples, the exterior surface of the central hub comprises splines and a corresponding interior surface of the clutch assembly comprises splines for spline interfacing.

The disclosure also provides support for a clutch gear assembly, comprising: a helical gear comprising a ring, and a clutch assembly comprising at least one clutch interface and a central hub, wherein the clutch assembly is coupled to an interior surface of the ring. In a first example of the system, in a single clutch arrangement, the clutch assembly comprises one clutch interface arranged at a first side of the central hub. In a second example of the system, optionally including the first example, in a dual-clutch arrangement, the clutch assembly comprises a first clutch interface arranged at a first side of the central hub and a second clutch interface at a second side of the central hub, the first side being opposite the second side. In a third example of the system, optionally including one or both of the first and second examples, an interior surface of the ring of the helical gear comprises a mating interface configured to couple to a corresponding mating interface of an outer surface of the clutch assembly.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multi-piece clutch gear assembly, comprising:
a helical gear; and
a clutch assembly coupled to and arranged within an interior of the helical gear, wherein the helical gear is formed as a first piece and the clutch assembly is formed as a separate, second piece.

2. The multi-piece clutch gear assembly of claim 1, wherein the clutch assembly comprises a central hub and at least one clutch interface.

3. The multi-piece clutch gear assembly of claim 1, wherein the helical gear comprises a ring, a central hub, and a plate formed as a single piece, wherein the clutch assembly is coupled to an interior surface of the ring and to an exterior surface of the central hub.

4. The multi-piece clutch gear assembly of claim 1, wherein, in a single clutch arrangement, the clutch assembly comprises a clutch interface positioned towards a first side of the clutch gear assembly and a central hub of the multi-piece clutch gear assembly is positioned more towards a second, opposing side of the clutch gear assembly than the clutch interface.

5. The multi-piece clutch gear assembly of claim 1, wherein, in a dual clutch arrangement, the clutch assembly comprises a first clutch interface positioned towards a first side of the clutch gear assembly and a second clutch interface positioned towards a second, opposing side of the clutch gear assembly.

6. The multi-piece clutch gear assembly of claim 1, wherein the helical gear comprises a plurality of teeth at an outer surface thereof configured to mesh with another gear.

7. The multi-piece clutch gear assembly of claim 1, wherein the helical gear is formed of cast iron, forged steel, or powdered metal.

8. The multi-piece clutch gear assembly of claim 1, wherein the clutch assembly is formed of cast iron, forged steel, or powdered metal.

9. The multi-piece clutch gear assembly of claim 1, wherein the helical gear and the clutch assembly are formed of different materials.

10. The multi-piece clutch gear assembly of claim 1, wherein the helical gear and the clutch assembly are configured to be affixed to each other via press fitting, a spline interface, or welding at a retention interface.

11. A clutch gear assembly, comprising:
a helical gear comprising a ring and a central hub, wherein the central hub is arranged within an interior of the ring along a shared axis of rotation; and
a clutch assembly comprising at least one clutch interface, wherein the clutch assembly is coupled to an interior surface of the ring and to an exterior surface of the central hub.

12. The clutch gear assembly of claim 11, wherein the central hub comprises an open passage there through, configured to receive a shaft.

13. The clutch gear assembly of claim 11, wherein the at least one clutch interface comprises a plurality of notches.

14. The clutch gear assembly of claim 11, wherein the at least one clutch interface comprises a first clutch interface at a first side of the clutch gear assembly.

15. The clutch gear assembly of claim 14, wherein the at least one clutch interface comprises a second clutch interface at a second side of the clutch gear assembly opposite the first side.

16. The clutch gear assembly of claim 11, wherein the exterior surface of the central hub comprises splines and a corresponding interior surface of the clutch assembly comprises splines for spline interfacing.

17. A clutch gear assembly, comprising:
a helical gear comprising a ring; and
a clutch assembly comprising at least one clutch interface and a central hub, wherein the clutch assembly is coupled to an interior surface of the ring.

18. The clutch gear assembly of claim 17, wherein in a single clutch arrangement, the clutch assembly comprises one clutch interface arranged at a first side of the central hub.

19. The clutch gear assembly of claim 17, wherein in a dual-clutch arrangement, the clutch assembly comprises a first clutch interface arranged at a first side of the central hub and a second clutch interface at a second side of the central hub, the first side being opposite the second side.

20. The clutch gear assembly of claim 17, wherein the interior surface of the ring of the helical gear comprises a mating interface configured to couple to a corresponding mating interface of an outer surface of the clutch assembly.
